(19) United States
(12) Patent Application Publication
(10) Pub. No.: US 2003/0163577 A1
(43) Pub. Date: Aug. 28, 2003

(54) Security system for accessing virtual private network service in communication network and method thereof

(76) Inventors: Se-Woong Moon, Songnam-shi (KR); Byung-Gu Choi, Seoul (KR)

Correspondence Address: Robert E. Bushnell, Suite 300, 1522 K Street, N.W., Washington, DC, 20005, US

(21) Appl. No.: 10/358,320

(22) Filed: Feb. 5, 2003

(30) Foreign Application Priority Data
Feb. 23, 2002 (KR) 2002-9785

(51) Int. Cl. G06F 15/16

(52) U.S. Cl. 709/229

(57) ABSTRACT

The present invention relates to a security system for accessing a private network service in a communication network and a method thereof, in which if a request of a subscriber for accessing a private network service is sensed, layer 2 tunnel protocol (L2TP) requests the virtual private network service access to a remote authentication dial-in user service server, and according to the request for accessing the private network service, the remote authentication dial-in user service server transfers layer 2 tunnel protocol (L2TP) information on layer 2 tunnel protocol (L2TP) network connected to the virtual private network, and pre-designated secret information in the layer 2 tunnel protocol (L2TP) network server to the layer 2 tunnel protocol (L2TP) access concentrator, and finally, after receiving the information on layer 2 tunnel protocol (L2TP) network and the secret information, the layer 2 tunnel protocol (L2TP) access concentrator performs encryption on the data generated by the subscriber by using the secret information, and transferring the encoded data to the layer 2 tunnel protocol (L2TP) network server.

### CLAIM OF PRIORITY

This application claims priority to an application entitled SECURITY SYSTEM FOR ACCESSING A VIRTUAL PRIVATE NETWORK SERVICE IN COMMUNICATION NETWORK AND METHOD THEREOF filed in the Korean Industrial Property Office on Feb. 23, 2002 and assigned Serial No. 9785/2002, the contents of which are hereby incorporated by reference.

### BACKGROUND OF THE INVENTION

1. Technical Field

The present invention relates generally to a virtual private network (VPN) system, and more particularly, to a security method for accessing a virtual private network service.

2. Related Art

Generally, a virtual private network system is a data network of public communication network based facility having a configuration adopted by a particular user group, such as a corporate group, applying a tunneling protocol and security procedure. In fact, the virtual private network, unlike other self-networks for only one user group or a dedicated private circuit, was originally developed to provide every user group with the same services of the self-network or dedicated private circuit while sharing the public network.

When a private network is connected to the Internet, there is a risk that unauthorized users will be able to view data sent to or from the private network. Efforts have been made to improve and secure network access. Exemplars of recent efforts in the art include U.S. Pat. No. 6,151,628 to Xu et al., entitled NETWORK ACCESS METHODS, INCLUDING DIRECT WIRELESS TO INTERNET ACCESS, issued on Nov. 21, 2000, U.S. Pat. No. 6,081,900 to Subramaniam et al., entitled SECURE INTRANET ACCESS, issued on Jun. 27, 2000, U.S. Pat. No. 6,061,796 to Chen et al., entitled MULTI-ACCESS VIRTUAL PRIVATE NETWORK, issued on May 9, 2000, U.S. Pat. No. 6,158,011 to Chen et al., entitled MULTI-ACCESS VIRTUAL PRIVATE NETWORK, issued on Dec. 5, 2000, U.S. Pat. No. 6,449,272 to Chuah et al., entitled MULTI-HOP POINT-TO-POINT PROTOCOL, issued on Sep. 10, 2002, U.S. Pat. No. 6,453,419 to Flint et al., entitled SYSTEM AND METHOD FOR IMPLEMENTING A SECURITY POLICY, issued on Sep. 17, 2002, U.S. Pat. No. 5,835,726 to Shwed et al., entitled SYSTEM FOR SECURING THE FLOW OF AND SELECTIVELY MODIFYING PACKETS IN A COMPUTER NETWORK, issued on Nov. 10, 1998, U.S. Pat. No. 6,304,973 to Williams, entitled MULTI-LEVEL SECURITY NETWORK SYSTEM, issued on Oct. 16, 2001, and Network Working Group Request for Comments No. 2661, entitled LAYER TWO TUNNELING PROTOCOL “L2TP”, by W. Townsley et al., dated August 1999.

While these recent efforts provide advantages, I note that they fail to adequately provide a security system for accessing virtual private network services in communication networks.

### SUMMARY OF THE INVENTION

The present invention provides a security system for securely accessing a private network service in a communication network. The present invention provides a method of utilizing a security system for securely accessing a private network service in a communication network.

In accordance with the principles of the present invention, as embodied and broadly described, the present invention provides a security method for accessing a private network service in communication network, the method including the steps of: if a request of a subscriber for accessing a private network service is sensed, requesting, at layer 2 tunnel protocol (L2TP), the virtual private network service access to a remote authentication dial-in user service server; according to the request for accessing a private network service, transferring, at the remote authentication dial-in user service server, layer 2 tunnel protocol (L2TP) information on layer 2 tunnel protocol (L2TP) network connected to the virtual private network, and pre-designated secret information in the layer 2 tunnel protocol (L2TP) network server to the layer 2 tunnel protocol (L2TP) access concentrator; and after receiving the information on layer 2 tunnel protocol (L2TP) network and the secret information, encoding, at the layer 2 tunnel protocol (L2TP) access concentrator, data generated by the subscriber by using the secret information, and transferring the encoded data to the layer 2 tunnel protocol (L2TP) network server.

Further, in accordance with the principles of the present invention, as embodied and broadly described, the present invention provides a security system for accessing a private network service in communication network, in which the system includes: layer 2 tunneling protocol (L2TP) having secret information for security of virtual private network service access for decoding inputted data by using the secret information, and for transferring the decoded data to the virtual private network; remote authentication dial-in user service server having secret information of a plurality of layer 2 tunnel protocol (L2TP) network servers, for sensing a request from a user for accessing a private network service, for searching secret information of a relevant layer 2 tunnel protocol (L2TP) network server that is connected to a relevant virtual private network of the subscriber, and for transferring server information and secret information of the relevant layer 2 tunnel protocol (L2TP) network server and security; and layer 2 tunnel protocol (L2TP) access concentrator for receiving server information and secret information of a relevant layer 2 tunnel protocol (L2TP) network server in accordance with the request for accessing the private network service, for encoding data that is generated by the subscriber by using the secret information, and transferring the encoded data to the relevant layer 2 tunnel protocol (L2TP) network server.

In accordance with the principles of the present invention, as embodied and broadly described, the present invention provides a method for securely accessing a virtual private network in a communication network, the method comprising: when a subscriber requests access to a virtual private network, transmitting a first access request from an access concentrator to a remote authentication dial-in user service (RADIUS) server; transferring server information and secret information of a first network server to the access concentrator, said transferring being performed in response to the first access request, the first network server being connected to the virtual private network; when the server information and the secret information are received by the access concentrator, encoding first data in dependence upon the secret information, said encoding being performed by the access concentrator, the first data being generated by the subscriber; sending the encoded first data from the access concentrator to the first network server in dependence upon the server information; decoding the encoded first data at the first network server, said decoding being performed in dependence upon the secret information; and conveying the decoded first data from the first network server to the virtual private network.

In accordance with the principles of the present invention, as embodied and broadly described, the present invention provides a system for securely accessing a network, the system comprising: a first device receiving a first request from a user when the user requests access to a virtual private network; a second device sensing the first request when said first device transmits the first request; and a third device being connected to the virtual private network, said third device being in communication with said first and second devices; said second device transferring first information of said third device to said first device in response to the first request, said second device transferring secret information to said first device in response to the first request; said first device receiving first data generated by the user, said first device encoding the first data in dependence upon the secret information, said first device sending the encoded first data to said third device; said third device receiving the encoded first data from said first device, decoding the encoded first data, and then conveying the decoded first data to the virtual private network, the decoding being performed in dependence upon the secret information.

In accordance with the principles of the present invention, as embodied and broadly described, the present invention provides a computer-readable medium having a set of computer-executable instructions for performing a method for securely accessing a virtual private network in a communication network, the set of instructions comprising one or more instructions for: when a subscriber requests access to a virtual private network, transmitting a first access request from an access concentrator to a remote authentication dial-in user service (RADIUS) server; transferring server information and secret information of a first network server to the access concentrator, said transferring being performed in response to the first access request, the first network server being connected to the virtual private network; when the server information and the secret information are received by the access concentrator, encoding first data in dependence upon the secret information, said encoding being performed by the access concentrator, the first data being generated by the subscriber; sending the encoded first data from the access concentrator to the first network server in dependence upon the server information; decoding the encoded first data at the first network server, said decoding being performed in dependence upon the secret information; and conveying the decoded first data from the first network server to the virtual private network.

The present invention is more specifically described in the following paragraphs by reference to the drawings attached only by way of example. Other advantages and features will become apparent from the following description and from the claims.

### BRIEF DESCRIPTION OF THE DRAWINGS

In the accompanying drawings, which are incorporated in and constitute a part of this specification, embodiments of the invention are illustrated, which, together with a general description of the invention given above, and the detailed description given below, serve to exemplify the principles of this invention.

FIG. 1 is a schematic diagram of a communication network;

FIG. 2 is a signal flow chart representing a procedure of establishing control connection for virtual private network access;

FIG. 3 is a signal flow chart representing a procedure of establishing a session for virtual private network access;

FIG. 4 is a schematic diagram of a communication network, in accordance with the principles of the present invention;

FIG. 5 is a signal flow chart representing a procedure used in the security during virtual private network service access, in accordance with the principles of the present invention; and

FIG. 6 is a diagram showing a packet data format that is used between a layer 2 tunnel protocol (L2TP) access concentrator and a layer 2 tunnel protocol (L2TP) network server illustrated in FIG. 5, in accordance with the principles of the present invention.

### DETAILED DESCRIPTION OF AN EMBODIMENT OF THE PRESENT INVENTION

While the present invention will be described more fully hereinafter with reference to the accompanying drawings, in which details of the present invention are shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

Illustrative embodiments of the invention are described below. In the interest of clarity, not all features of an actual implementation are described. In the following description, well-known functions, constructions, and configurations are not described in detail since they could obscure the invention with unnecessary detail. It will be appreciated that in the development of any actual embodiment numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill having the benefit of this disclosure.

Transmitting data in a virtual private network can involve data encryption being performed before sending the data to the receiving side through the public network, and the receiving side then decoding the encrypted data.

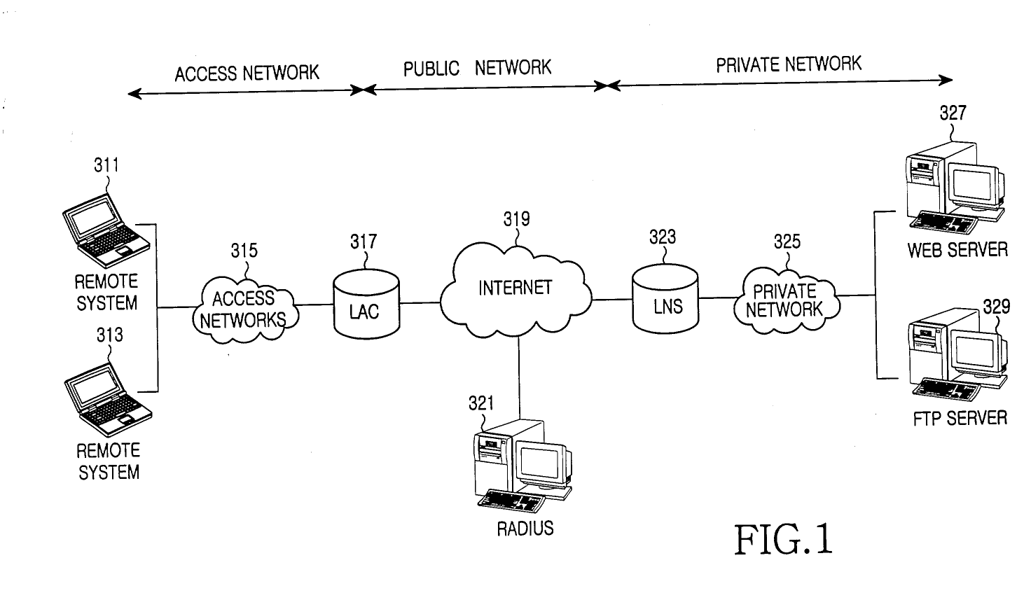

A communication network including the private network is now explained with reference to FIG. 1. FIG. 1 diagrammatically shows a configuration of a communication network.

Referring to FIG. 1, remote systems 311 and 313, which are virtual private network subscribers, first perform dial-up onto virtual private network 325 for a virtual private network service access. Since the remote system 311 and another remote system 313 have the same functions, only the remote system 311 will be considered when explaining the present invention. As the remote system 311 performs dial-up for the virtual private network service access, it accesses access network 315 of a specific Internet service provider (ISP). Accessing a remote access server (RAS) is another typically used method for the virtual private network service access besides the dial-up method. However, accessing a remote access server is defective compared to the dial-up method in terms of costs.

Therefore, as shown in FIG. 1, the remote system accesses the access network 315 using the dial-up method, and the access network 315 accesses layer 2 tunneling protocol (L2TP) layer access concentrator (LAC) 317. The layer 2 tunneling protocol is also known as L2TP. The layer 2 tunnel protocol (L2TP) layer access concentrator 317 is also known as LAC 317. Here, the layer 2 tunnel protocol (L2TP) is a protocol for tunneling particularly between the remote system 311 and the virtual private network 325. Besides the layer 2 tunnel protocol (L2TP) for tunneling with the remote system 311, other kinds of protocols, such as, for example, layer 2 forwarding (L2F) or point to point tunneling protocol (PPTP) can be used in the virtual private network 325. In FIG. 1 the layer 2 tunnel protocol (L2TP) protocol has been employed as a tunneling protocol. The layer 2 tunnel protocol (L2TP) access concentrator 317 authenticates packet data that was generated in the remote system 311 through remote authentication dial-in user service (RADIUS) server 321, and then transfers the packet data to layer 2 tunnel protocol (L2TP) network server (LNS) 323 through Internet 319. Here, when the Remote Authentication Dial-in User Service server 321 performs authentication based on a user identifier (ID) of the remote system 311, and if the authentication is successfully done, the remote authentication dial-in user service (RADIUS) server 321 decides through which virtual private network tunnel the remote system 311 should transfer the packet data, and transfers the packet data to the layer 2 tunnel protocol (L2TP) access concentrator 317. Then, the layer 2 tunnel protocol (L2TP) access concentrator 317 transfers the packet data from the remote system 311 to the layer 2 tunnel protocol (L2TP) network server 323 that is connected to a relevant virtual private network. Here, when the remote authentication dial-in user service (RADIUS) server 321 decides through which virtual private network tunnel the remote system 311 should transfer the packet data, it actually decides to which layer 2 tunnel protocol (L2TP) network the remote system 311 should be accessed.

Once the layer 2 tunnel protocol (L2TP) network server 323 receives the packet data of the remote system 311 from the layer 2 tunnel protocol (L2TP) access concentrator 317, it assigns an Internet protocol (IP) address for the remote system 31 1 in order to transfer the packet data of the remote system 311 to the virtual private network 325. In short, the packet data of the remote system 311 is transferred to the virtual private network 325 through the assigned IP address. The virtual private network 325 generates an IP tunnel for the remote system 311, and enables the virtual private network service over the Internet, and as mentioned before, it allows only specially authenticated users to have an access to the service. Lastly, the virtual private network 325, having received the packet data of the remote system 311 from the L1TP network server 323, transfers the packet data to a relevant server, for instance, to a web server 327 or to FTP server 329. Here, the web server 327 and the FTP server 329 are the ones for performing the virtual private network service.

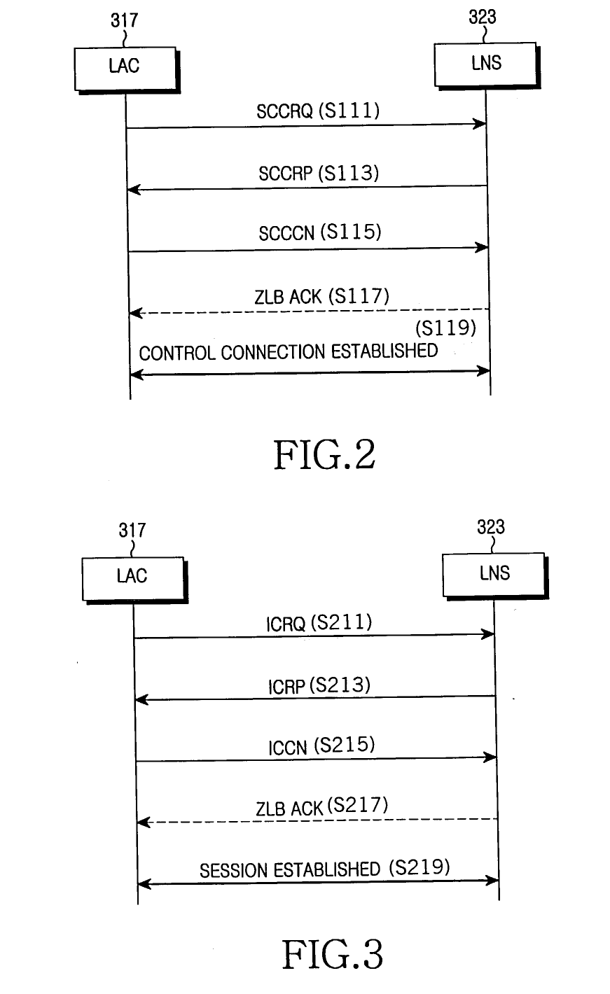

The following is a procedure of establishing control connection, explained with reference to FIG. 2. FIG. 2 is a signal flow chart representing a procedure for establishing control connection for virtual private network access.

The control connection means an initial connection that has to be established for an actual subscriber to use layer 2 tunnel protocol (L2TP) before an actual session is generated between the layer 2 tunnel protocol (L2TP) access concentrator 317 and the layer 2 tunnel protocol (L2TP) network server 323. At step S111, as shown in the drawing, first of all, layer 2 tunnel protocol (L2TP) access concentrator 317 transfers Start-Control-Connect-ReQuest (hereinafter, referred to as “SCCRQ”) message to the layer 2 tunnel protocol (L2TP) network server 323 to initialize a tunnel between the layer 2 tunnel protocol (L2TP) access concentrator 317 and layer 2 tunnel protocol (L2TP) network server 323. At step S113, after receiving the SCCRQ message from the layer 2 tunnel protocol (L2TP) access concentrator 317, the layer 2 tunnel protocol (L2TP) network server 323 designates a tunnel between the layer 2 tunnel protocol (L2TP) access concentrator 317 and the layer 2 tunnel protocol (L2TP) network server 323, and later it transfers Start-Control-Connect-RePly (hereinafter, referred to as “SCCRP”) message to the layer 2 tunnel protocol (L2TP) access concentrator 317 in response to the SCCRQ message.

At step S115, having received the SCCRP message, the layer 2 tunnel protocol (L2TP) access concentrator 317 transfers Start-Control-Connection-Connected (hereinafter, referred to as “SCCCN”) message to the layer 2 tunnel protocol (L2TP) network server 323 in response to the SCCRP message. More specifically, when the layer 2 tunnel protocol (L2TP) access concentrator (LAC) 317 receives the SCCRP message, the LAC 317 recognizes that a tunnel is being established between the layer 2 tunnel protocol (L2TP) access concentrator 317 and the layer 2 tunnel protocol (L2TP) network server 323. In other words, the tunnel is established after the SCCCN message is output from the layer 2 tunnel protocol (L2TP) access concentrator 317. The LAC 317 transfers the SCCCN message to the layer 2 tunnel protocol (L2TP) network server 323. Thus, the three-way handshaking used for layer 2 tunnel protocol (L2TP) is similar to the three-way handshaking used for transmission control protocol (TCP). First, a request side sends a request to a reply side. Next, the reply side sends the acceptance. Last, the request side sends a notify message. Then the tunnel state, or TCP session, is changed to an “established” state.

At step S117, upon receiving the SCCCN message, the layer 2 tunnel protocol (L2TP) network server 323 transfers Zero-Length Body (hereinafter, referred to as “ZLB”) ACK message to the layer 2 tunnel protocol (L2TP) access concentrator 317. Actually, the ZLB ACK message is sent when there is no message transference between the layer 2 tunnel protocol (L2TP) access concentrator 317 and the layer 2 tunnel protocol (L2TP) network server 323, and the ZLB message normally informs that packet data is being transferred through a stabilized control channel. Therefore, the control connection establishment between the layer 2 tunnel protocol (L2TP) access concentrator 317 and the layer 2 tunnel protocol (L2TP) network server 323 is not completed until the layer 2 tunnel protocol (L2TP) access concentrator 317 receives the ZLB ACK message. At step S119, the control connection establishment between the layer 2 tunnel protocol (L2TP) access concentrator 317 and the layer 2 tunnel protocol (L2TP) network server is completed.

If packet data from the remote system 311 is inputted into the layer 2 tunnel protocol (L2TP) access concentrator 317 following the establishment of the control connection between the layer 2 tunnel protocol (L2TP) access concentrator 317 and the layer 2 tunnel protocol (L2TP) network server 323, that is, if an access is required, a session should be established for packet data communication using an actual layer 2 tunnel protocol (L2TP). Therefore, the session establishment procedure is described next with reference to FIG. 3.

FIG. 3 is a signal flow chart depicting a session establishment procedure for virtual private network access. At step S211, to begin with, when layer 2 tunnel protocol (L2TP) access concentrator 317 senses an access request from a subscriber, or a remote system 311, it transfers Incoming-Call-ReQuest (hereinafter, referred to as “ICRQ”) to layer 2 tunnel protocol (L2TP) network server 323. To transfer the ICRQ message, a tunnel should be first established between the layer 2 tunnel protocol (L2TP) access concentrator 317 and the layer 2 tunnel protocol (L2TP) network server 323, and there should be an incoming call from a subscriber. At step S213, upon receiving the ICRQ message, the layer 2 tunnel protocol (L2TP) network server 323 transfers Incoming-Call-Reply (hereinafter, referred to as “ICRP”) message to the layer 2 tunnel protocol (L2TP) access concentrator 317. Here, the ICRP message is a message in response to the ICRQ message, indicating that the request of the incoming call has been successfully satisfied.

At step S215, after receiving the ICRP message, the layer 2 tunnel protocol (L2TP) access concentrator 317 transfers Incoming-Call-connected (hereinafter, referred to as “ICCN”) message to the layer 2 tunnel protocol (L2TP) network server 323 in response to the ICRP message. In short, the session establishment is completed as the layer 2 tunnel protocol (L2TP) access concentrator 317 transfers the ICCN message to the layer 2 tunnel protocol (L2TP) network server 323. At step S217, when the layer 2 tunnel protocol (L2TP) network server 323 receives the ICCN message, the layer 2 tunnel protocol (L2TP) network server 323 transfers ZLB ACK message to the layer 2 tunnel protocol (L2TP) access concentrator 317. The ZLB ACK message is sent when there is no message transference between the layer 2 tunnel protocol (L2TP) access concentrator 317 and the layer 2 tunnel protocol (L2TP) network server 323, and the ZLB message normally informs that packet data is being transferred through a stabilized control channel. Therefore, the session establishment between the layer 2 tunnel protocol (L2TP) access concentrator 317 and the layer 2 tunnel protocol (L2TP) network server 323 is not completed until the layer 2 tunnel protocol (L2TP) access concentrator 317 receives the ZLB ACK message. At step S219, the session establishment between the layer 2 tunnel protocol (L2TP) access concentrator 317 and the layer 2 tunnel protocol (L2TP) network server 323 is completed. Here, message flow of the layer 2 tunnel protocol (L2TP) is disclosed in “Layer Two Tunneling Protocol L2TP” of RFC 2661.

Following the establishment of a session between the layer 2 tunnel protocol (L2TP) access concentrator 317 and the layer 2 tunnel protocol (L2TP) network server 323, all packet data from the remote system 311 is sent to the virtual private network 325, using a relevant link. Usually, the layer 2 tunnel protocol (L2TP) access concentrator 317 and the layer 2 tunnel protocol (L2TP) network server 323 are connected through Internet 319. Since all traffic of subscribers using the Internet 319 is exposed to the public by the nature of Internet, there could be serious problems with security. In other words, in spite of using a virtual private network, since all data is transported through Internet, the public network, any one can monitor the data.

An embodiment of the present invention will be described herein below with reference to the accompanying drawings. In the following description, well-known functions or constructions are not described in detail since they would obscure the invention in unnecessary detail.

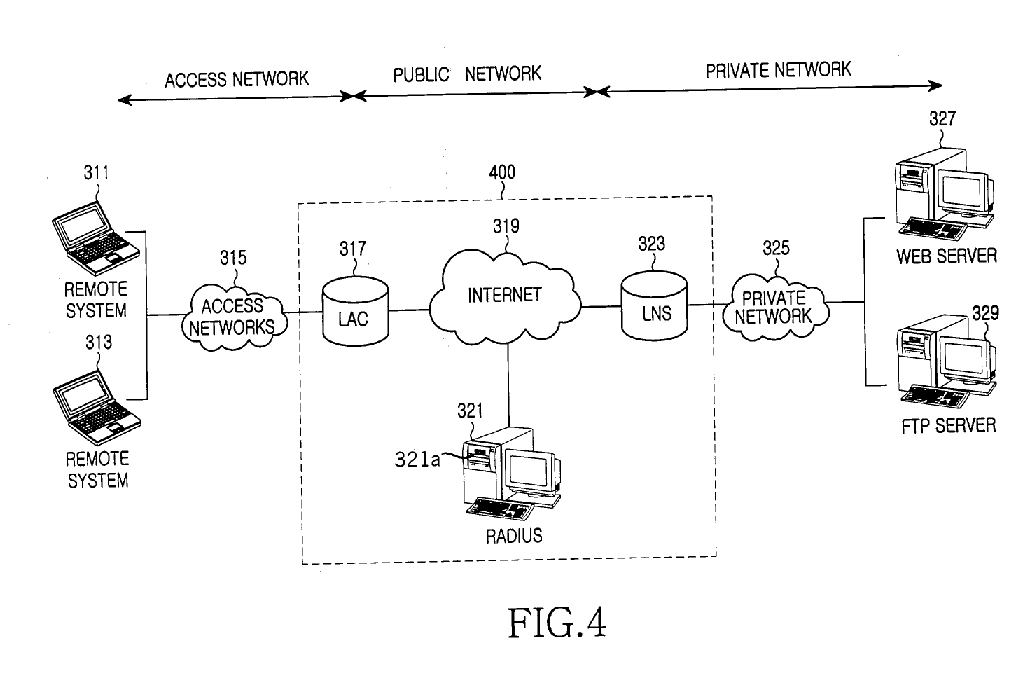

FIG. 4 shows a configuration of a communication network, in accordance with the principles of the present invention. Referring to FIG. 4, remote systems 311 and 313, which are virtual private network subscribers, first perform dial-up onto virtual private network 325 for a virtual private network service access. Since the remote system 311 and another remote system 313 have the same functions, only the remote system 311 will be considered for the convenience of explaining the present invention. As the remote system 311 performs dial-up for the virtual private network service access, it accesses access network 315 of a specific Internet service provider (ISP). Besides the dial-up method, there is another way to get the virtual private network service access, such as, using a remote access server (RAS). However, using the RAS is very costly compared to the dial-up method.

Therefore, as shown in FIG. 4, the remote system accesses the access network 315 using the dial-up method, and the access network 315 accesses layer 2 tunneling protocol (hereinafter, referred to as “L2TP”) layer access concentrator (LAC, to be more specific, L2TP Access concentrator) 317. Here, the layer 2 tunnel protocol (L2TP) is a protocol for tunneling particularly between the remote system 311 and the virtual private network 325. Besides the layer 2 tunnel protocol (L2TP) for tunneling with the remote system 311, other kinds of protocols, for example, L2F (Layer 2 Forwarding) or PPTP (Point to Point Tunneling Protocol) can be used in the virtual private network 325, but in the drawing, the layer 2 tunnel protocol (L2TP) protocol has been employed as a tunneling protocol. The layer 2 tunnel protocol (L2TP) access concentrator 317 authenticates packet data that was generated in the remote system 311 through Remote Authentication Dial-in User Service server 321 (RADIUS server), and then transfers the packet data to layer 2 tunnel protocol (L2TP) network server (LNS) 323 through Internet 319. Especially, in the present invention, the remote authentication dial-in user service (RADIUS) server 321 stores secret keys peer to peer the layer 2 tunnel protocol (L2TP) network server 323.

Here, for the sake of the security of packet data transferred to the virtual private network 325, the secret keys are designated in the layer 2 tunnel protocol (L2TP) network server 323 connected to the virtual private network 325, and the secret key of the layer 2 tunnel protocol (L2TP) network server 323 is managed by the remote authentication dial-in user service (RADIUS) server 321. The secret key is given when layer 2 tunnel protocol (L2TP) access concentrator 317 is generated, requesting to the remote authentication dial-in user service (RADIUS) server 321 for an access to the layer 2 tunnel protocol (L2TP) network server 323. Then, for security, the layer 2 tunnel protocol (L2TP) access concentrator 317, using the secret key, performs encryption on packet data that are transferred to the layer 2 tunnel protocol (L2TP) network servers 323. The security system using the secret key is also pre-designated between the remote authentication dial-in user service (RADIUS) server 321 and the layer 2 tunnel protocol (L2TP) network server 323, and together with the secret key, the security system is later transferred to the layer 2 tunnel protocol (L2TP) access concentrator 317. Another example of the security system is Null encryption.

Finally, the Remote Authentication Dial-in User Service server 321 performs authentication based on a user identifier (ID) of the remote system 311. If the authentication is successfully done, the remote authentication dial-in user service (RADIUS) server 321 makes a decision and performs a transfer at the same time. More particularly, remote authentication dial-in user service (RADIUS) server 321 decides through which virtual private network tunnel, that is, through which layer 2 tunnel protocol (L2TP) network server, the remote system 311 should transfer the packet data, and at the same time, remote authentication dial-in user service (RADIUS) server 321 transfers the pre-designated secret key and the security system to the layer tunnel protocol (L2TP) access concentrator 317. Thus, remote authentication dial-in user 2 service (RADIUS) 321 determines which VPN tunnel, or which L2TPNS, that the remote system 311 should transfer packet data to, and, at the same time that determination is made, remote authentication dial-in user service (RADIUS) 321 transfers the secret key to the layer 2 tunnel protocol (L2TP) access concentrator 317.

Then, before sending the packet data from the remote system 311 to the layer 2 tunnel protocol (L2TP) network server (LNS) 323 connected to a relevant virtual private network, the layer 2 tunnel protocol (L2TP) access concentrator 317 performs encryption on the packet data using the secret key in conforming to the security system. In this manner, the data is well secured from any possible intrusion. The reference numeral 400 in FIG. 4 indicates a part to which the security system using the secret key for the data to be transferred is applied. That is, the security system is applied for communications across the Internet between the layer 2 tunnel protocol (L2TP) access concentrator 317, the remote authentication dial-in user service (RADIUS) 321, and the layer 2 tunnel protocol (L2TP) network server 323.

With reference to FIG. 4, a user wants to access the virtual private network 325. The user sits down at the remote terminal 311. The remote terminal 311 can be a computer system such as a personal computer (PC), a desktop computer, a workstation, a server, a portable computer, a notebook computer, a hand-held computer, a palm-sized computer, a wearable computer, or any other type of computer system.

With continued reference to FIG. 4, the user enters a command at the remote terminal 311, and the command corresponds to a request to access the virtual private network 325 to make use of virtual private network services provided there. The request, or a corresponding transmission, is then sent from the remote terminal 311 to the access network 315. The request, or a corresponding transmission, is then sent from the access network 315 to the layer 2 tunneling protocol layer access concentrator (LAC) 317. The request, or a corresponding transmission, is then sent from the LAC 317 through the Internet 319. The remote authentication dial-in user service (RADIUS) server 321 detects or senses the request sent from the LAC 317. The RADIUS server 321 acquires server information corresponding to layer 2 tunnel protocol network server (LNS) 323 and also acquires secret information. The RADIUS server 321 sends the server information and the secret information to the LAC 317. The layer 2 tunneling protocol layer access concentrator (LAC) 317 uses the secret information to encode data generated by the user. The LAC 317 then sends the encoded data through the Internet 319 to the LNS 323 using the server information. The layer 2 tunnel protocol network server (LNS) 323 then decodes the encoded data using the secret information. The LNS 323 then sends the decoded data to the virtual private network 325. In this way, the user can access the virtual private network (VPN) 325 securely, even though the user is accessing the VPN 325 through the Internet. Therefore, in view of the foregoing, the user can access the VPN 325 through the Internet, but unauthorized users connected to the Internet cannot view the data being sent to and from the VPN 325. Also, in response to requests by remote terminal 311, the LNS 323 encodes data received from the VPN 325 using the secret information and then sends the encoded data to the LAC 317. The LAC 317 decodes the data using the secret information and then sends the decoded data to the remote terminal 311. The encoding and decoding is performed in dependence upon the secret information.

After the layer 2 tunnel protocol (L2TP) network server 323 receives the packet data of the remote system 311 from the layer 2 tunnel protocol (L2TP) access concentrator 317, the layer 2 tunnel protocol (L2TP) network server 323 assigns an IP address for the remote system 311 in order to transfer the packet data of the remote system 311 to the virtual private network 325. In short, the packet data of the remote system 311 is transferred to the virtual private network 325 through the assigned IP address. The virtual private network 325 generates an IP tunnel for the remote system 311, and enables the virtual private network service over the Internet, and as mentioned before, it allows only specially authenticated users to have an access to the service. Lastly, the virtual private network 325, having received the packet data of the remote system 311 from the layer 2 tunnel protocol (L2TP) network server 323, transfers the packet data to a relevant server, for instance, to a web server 327 or to FTP server 329. Here, the web server 327 and the FTP server 329 are the ones performing the virtual private network service.

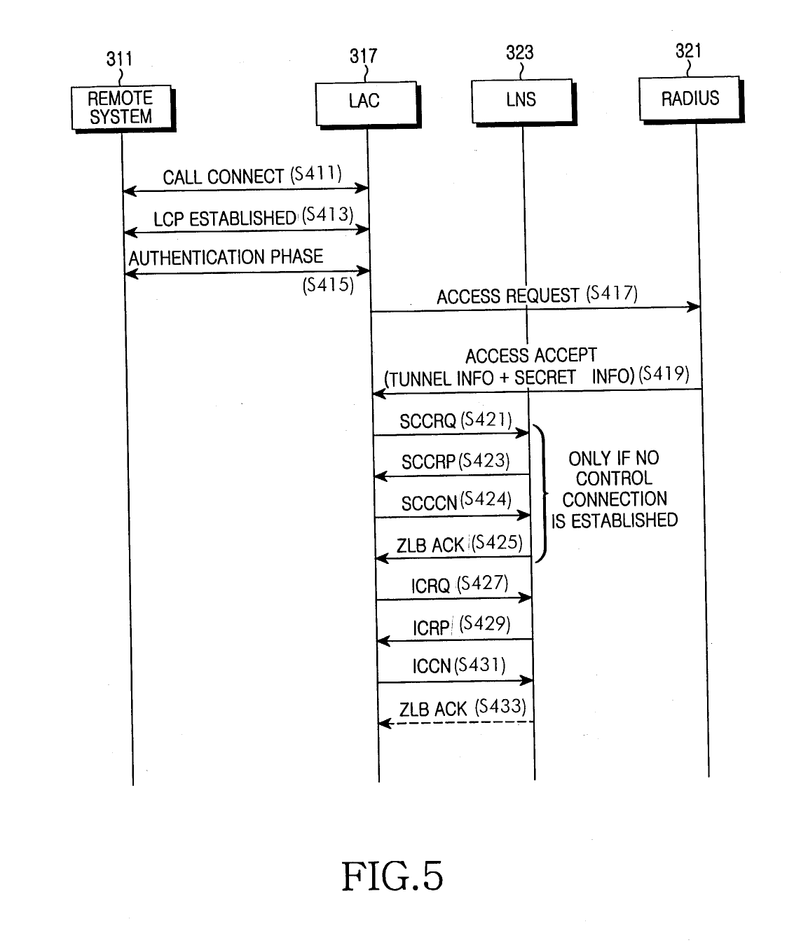

With reference to FIG. 5, the following explains the procedure used in the security during the virtual private network service access. FIG. 5 is a signal flow chart representing a procedure used in the security system during virtual private network service access, in accordance with the principles of the present invention.

As shown in FIGS. 4 and 5, the remote system 311 makes a request to a specific access network of Internet service provider, that is, to the access network 315, for the virtual private network service access through dial-up. At step S441, the access network 315 checks the request of the remote system 311 for the virtual private network service access, and performs call connection between the layer 2 tunnel protocol (L2TP) access concentrator 317 and the remote system 311, given that the remote system 311 is properly authenticated. At step S413, if the call connection is completed between the remote system 311 and the layer 2 tunnel protocol (L2TP) access concentrator 317, link layer control protocol (LCP) is established.

Here, the link layer control protocol (LCP) indicates a control protocol used for the access between peers (peer-to-peer) through point-to-point protocol (PPP). More specifically, after making the access using, such as, the link layer control protocol (LCP), network layer control protocol (DCP) or Internet protocol control protocol (IPCP), the authentication procedure (PAP or CHAP) comes next, and if lower access (LCP and authentication) is succeeded, Internet protocol related information is switched in the network layer, consequently completing the designation. PAP refers to password authentication protocol. CHAP refers to challenge handshake authentication protocol.

At step S415, when the LCP is established between the remote system 311 and the layer 2 tunnel protocol (L2TP) access concentrator 317, an authentication phase is carried out between the remote system 311 and the layer 2 tunnel protocol (L2TP) access concentrator 317. Here, the authentication phase involves using the information of the remote system 311 that has been received through the access server 315, for example, information like telephone numbers, to authenticate if the remote system 311 is the virtual private network service accessible.

At step S417, after the authentication between the remote system 311 and the layer 2 tunnel protocol (L2TP) access concentrator 317 is successfully done, the layer 2 tunnel protocol (L2TP) access concentrator 317 transfers an access request message to the remote authentication dial-in user service server (RADIUS server) 321. Here, as the layer 2 tunnel protocol (L2TP) access concentrator 317 requests an access to the remote authentication dial-in user service (RADIUS) server 321, the information of the remote system 311 is transferred together with the request. Then, upon receiving the access request from the layer 2 tunnel protocol (L2TP) access concentrator 317, the remote authentication dial-in user service (RADIUS) server 321 performs authentication on the remote system 311, and determines a relevant tunnel of the remote system 311, that is, a relevant layer 2 tunnel protocol (L2TP) network server for the remote system 311. In other words, the remote authentication dial-in user service (RADIUS) server 321 searches layer 2 tunnel protocol (L2TP) network servers that are connected to the virtual private network, and selects a layer 2 tunnel protocol (L2TP) network server to which the remote system 311 should access.

At the time of choosing a layer 2 tunnel protocol (L2TP) network server for the remote system 311, the remote authentication dial-in user service (RADIUS) server 321 also searches pre-designated secret information, that is, secret key and security system, for the selected layer 2 tunnel protocol (L2TP) network servers 323. At step S419, the remote authentication dial-in user service (RADIUS) server 321 transfers an access accept message including tunnel information and secret information regarding the remote system 311 to the layer 2 tunnel protocol (L2TP) access concentrator 317. In short, the authentication between the layer 2 tunnel protocol (L2TP) access concentrator 317 and the remote authentication dial-in user service (RADIUS) server 321 is completed as the layer 2 tunnel protocol (L2TP) access concentrator 317 receives the access accept message from the remote authentication dial-in user service (RADIUS) server 321.

Once the authentication between the layer 2 tunnel protocol (L2TP) access concentrator 317 and the remote authentication dial-in user service (RADIUS) server 321 is completed, the layer 2 tunnel protocol (L2TP) access concentrator 317 starts a procedure for establishing control connection with the layer 2 tunnel protocol (L2TP) network server 323. The control connection means an initial connection that has to be established for an actual subscriber to use layer 2 tunnel protocol (L2TP) before an actual session is generated between the layer 2 tunnel protocol (L2TP) access concentrator 317 and the layer 2 tunnel protocol (L2TP) network server 323. If the control connection between the layer 2 tunnel protocol (L2TP) access concentrator 317 and the layer 2 tunnel protocol (L2TP) network server 323 has been already established, then steps S421-S425 will not be performed.

The procedure of establishing the control connection shall now be explained. At step S421, first of all, layer 2 tunnel protocol (L2TP) access concentrator 317 transfers Start-Control-Connect-ReQuest (hereinafter, referred to as “SCCRQ”) message to the layer 2 tunnel protocol (L2TP) network server 323 to initialize a tunnel between the layer 2 tunnel protocol (L2TP) access concentrator 317 and layer 2 tunnel protocol (L2TP) network server 323. At step S423, after receiving the SCCRQ message from the layer 2 tunnel protocol (L2TP) access concentrator 317, the layer 2 tunnel protocol (L2TP) network server 323 designates a tunnel between the layer 2 tunnel protocol (L2TP) access concentrator 317 and the layer 2 tunnel protocol (L2TP) network server 323, and later it transfers Start-Control-Connect-RePly (hereinafter, referred to as “SCCRP”) message to the layer 2 tunnel protocol (L2TP) access concentrator 317 in response to the SCCRQ message.

At step S424, having received the SCCRP message, the layer 2 tunnel protocol (L2TP) access concentrator 317 transfers Start-Control-Connection-Connected (hereinafter, referred to as “SCCCN”) message to the layer 2 tunnel protocol (L2TP) network server 323 in response to the SCCRP message. More specifically, when the layer 2 tunnel protocol (L2TP) access concentrator (LAC) 317 receives the SCCRP message, the LAC 317 recognizes that a tunnel is being established between the layer 2 tunnel protocol (L2TP) access concentrator 317 and the layer 2 tunnel protocol (L2TP) network server 323. In other words, the tunnel is established after the SCCCN message is output from the layer 2 tunnel protocol (L2TP) access concentrator 317. The LAC 317 transfers the SCCCN message to the layer 2 tunnel protocol (L2TP) network server 323.

At step S425, upon receiving the SCCCN message, the layer 2 tunnel protocol (L2TP) network server 323 transfers Zero-Length Body (hereinafter, referred to as “ZLB”) ACK message to the layer 2 tunnel protocol (L2TP) access concentrator 317. Actually, the ZLB ACK message is sent when there is no message transference between the layer 2 tunnel protocol (L2TP) access concentrator 317 and the layer 2 tunnel protocol (L2TP) network server 323, and the ZLB message normally informs that packet data is being transferred through a stabilized control channel. Therefore, the control connection establishment between the layer 2 tunnel protocol (L2TP) access concentrator 317 and the layer 2 tunnel protocol (L2TP) network server 323 is not completed until the layer 2 tunnel protocol (L2TP) access concentrator 317 receives the ZLB ACK message.

If packet data from the remote system 311 is inputted into the layer 2 tunnel protocol (L2TP) access concentrator 317 following the establishment of the control connection between the layer 2 tunnel protocol (L2TP) access concentrator 317 and the layer 2 tunnel protocol (L2TP) network server 323, that is, if an access is required, a session should be established for packet data communication using an actual layer 2 tunnel protocol (L2TP).

At step S427, to begin with, when layer 2 tunnel protocol (L2TP) access concentrator 317 senses an access request from a subscriber, or a remote system 311, it transfers. Incoming-Call-ReQuest (hereinafter, referred to as “ICRQ”) to layer 2 tunnel protocol (L2TP) network server 323. To transfer the ICRQ message, a tunnel should be first established between the layer 2 tunnel protocol (L2TP) access concentrator 317 and the layer 2 tunnel protocol (L2TP) network server 323, and there should be an incoming call from a subscriber. At step S429, upon receiving the ICRQ message, the layer 2 tunnel protocol (L2TP) network server 323 transfers Incoming-Call-Reply (hereinafter, referred to as “ICRP”) message to the layer 2 tunnel protocol (L2TP) access concentrator 317. Here, the ICRP message is a message in response to the ICRQ message, indicating that the request of the incoming call has been successfully satisfied.

At step S431, after receiving the ICRP message, the layer 2 tunnel protocol (L2TP) access concentrator 317 transfers Incoming-Call-connected (hereinafter, referred to as “ICCN”) message to the layer 2 tunnel protocol (L2TP) network server 323 in response to the ICRP message. In short, the session establishment is completed as the layer 2 tunnel protocol (L2TP) access concentrator 317 transfers the ICCN message to the layer 2 tunnel protocol (L2TP) network server 323. At step S433, when the layer 2 tunnel protocol (L2TP) network server 323 receives the ICCN message, the layer 2 tunnel protocol (L2TP) network server 323 transfers ZLB ACK message to the layer 2 tunnel protocol (L2TP) access concentrator 317. The ZLB ACK message is sent when there is no message transference between the layer 2 tunnel protocol (L2TP) access concentrator 317 and the layer 2 tunnel protocol (L2TP) network server 323, and the ZLB message normally informs that packet data is being transferred through a stabilized control channel. Therefore, the session establishment between the layer 2 tunnel protocol (L2TP) access concentrator 317 and the layer 2 tunnel protocol (L2TP) network server 323 is not completed until the layer 2 tunnel protocol (L2TP) access concentrator 317 receives the ZLB ACK message.

Following the establishment of a session between the layer 2 tunnel protocol (L2TP) access concentrator 317 and the layer 2 tunnel protocol (L2TP) network server 323, all packet data from the remote system 311 is sent to the virtual private network 325, using a relevant link.

In summary, as shown in FIG. 5, when the remote system 311 accesses the virtual private network 325 using layer 2 tunnel protocol (L2TP) tunneling, the remote system 311 performs encryption on all of the data, which are actually transferred, using the secret key and security system. As a result, the data security is successfully maintained.

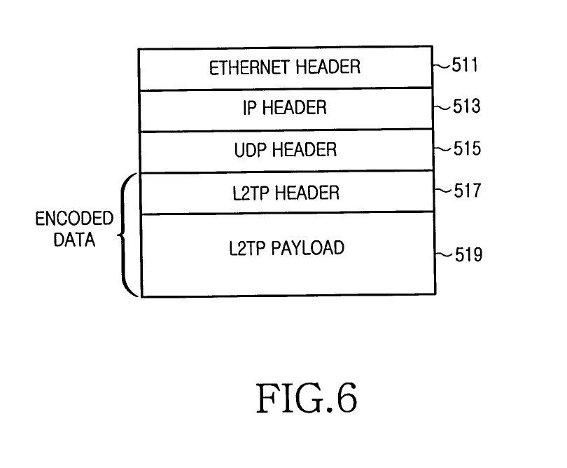

Referring to FIG. 6, explained next is a packet data format used between the layer 2 tunnel protocol (L2TP) access concentrator 317 and the layer 2 tunnel protocol (L2TP) network server 323. FIG. 6 is a diagram showing a packet data format that is used between a layer 2 tunnel protocol (L2TP) access concentrator 317 and a layer 2 tunnel protocol (L2TP) network server 323 illustrated in FIG. 5, in accordance with the principles of the present invention.

As depicted in the drawing, packet data format used between the layer 2 tunnel protocol (L2TP) access concentrator 317 and the layer 2 tunnel protocol (L2TP) network server 323 has regions of Ethernet header 511, Internet protocol (IP) header 513, user datagram protocol (UDP) header 515, layer 2 tunnel protocol (L2TP) header 517, and layer 2 tunnel protocol (L2TP) payload 519. IP header 513 includes IP relevant data that have been assigned between the layer 2 tunnel protocol (L2TP) access concentrator 317 and the layer 2 tunnel protocol (L2TP) network server 323. UDP (User Datagram Protocol) header 515 includes UDP relevant data that have been assigned between the layer 2 tunnel protocol (L2TP) access concentrator 317 and the layer 2 tunnel protocol (L2TP) network server 323. Layer2 tunnel protocol (L2TP) header 517 includes layer 2 tunnel protocol (L2TP) tunneling relevant data between the layer 2 tunnel protocol (L2TP) access concentrator 317 and the layer 2 tunnel protocol (L2TP) network server 323 The layer 2 tunnel protocol (L2TP) payload 519 includes packet data that has been transferred from the remote system 311. The layer 2 tunnel protocol (L2TP) header 517 also includes information like tunnel identifier (ID), and session identifier (ID). Moreover, the layer 2 tunnel protocol (L2TP) header region 517 and the layer 2 tunnel protocol (L2TP) payload region 519 are encoded in conformance with the security system using the secret key as described before.

In an embodiment of the present invention, the above-described steps of the present invention can be instructions stored in a memory, and the instructions stored in the memory can be performed by one or more computers. The memory could be any kind of computer readable medium such as floppy disks, conventional hard disks, removable hard disks, compact discs (CDs), digital versatile discs (DVDs), flash read only memory (flash ROM), nonvolatile read only memory, and random access memory (RAM), for example. The remote authentication dial-in user service (RADIUS) server 321 includes a hard disk drive 321a, the remote system 311 includes a hard disk drive, and the web server 327 includes a hard disk drive.

In an embodiment of the present invention, at least one of the above-described steps of the present invention can correspond to an execution of instructions stored in one or more memory units. For example, one of these memory units could be the hard disk drive 321a installed in the remote authentication dial-in user service (RADIUS) server 321. Instructions stored in such a memory unit can be executed or performed by one or more computers. For example, instructions corresponding to some of the steps of the present invention can be stored in the hard disk drive 321a installed in the remote authentication dial-in user service (RADIUS) server 321 shown in FIG. 4.

A software implementation of the above-described embodiment may comprise a series of computer instructions either fixed on a tangible medium, such as computer readable media, for example a compact disc or a fixed disk, or transmissible to a computer system via a modem or other interface device over a medium. The medium can be either a tangible medium, including, but not limited to, optical or analog communications lines, or may be implemented with wireless techniques, including but not limited to microwave, infrared or other transmission techniques. The medium may also be the Internet. The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, for example, shrink wrapped software, pre-loaded with a computer system, for example, on system read only memory (ROM) or fixed disk, or distributed from a server or electronic bulletin board over a network, for example, the Internet or World Wide Web.

In conclusion, the present invention is advantageous in terms of maintaining security of data transmission. That is, when a subscriber accesses to the virtual private network through dial-up in the communication network, not just data, but the encoded data that has been encoded using secret information are transferred. Therefore, even when the subscriber uses a public network, the data can be well secured against any intrusion or hacking. Thus, as the security of data transmission is well maintained, the usage safety of virtual private network can be improved also.

While the present invention has been illustrated by the description of embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departing from the spirit or scope of the applicant's general inventive concept.

What is claimed is:

1. A method for securely accessing a virtual private network in a communication network, the method comprising:
when a subscriber requests access to a virtual private network, transmitting a first access request from an access concentrator to, a remote authentication dial-in user service (RADIUS) server;
transferring server information and secret information of a first network server to the access concentrator, said transferring being performed in response to the first access request, the first network server being connected to the virtual private network;
when the server information and the secret information are received by the access concentrator, encoding first data in dependence upon the secret information, said encoding being performed by the access concentrator, the first data being generated by the subscriber;
sending the encoded first data from the access concentrator to the first network server in dependence upon the server information;
decoding the encoded first data at the first network server, said decoding being performed in dependence upon the secret information; and
conveying the decoded first data from the first network server to the virtual private network.

2. The method of claim 1, the server information including layer 2 tunnel protocol (L2TP) information, the first network server being a layer 2 tunnel protocol network server.

3. The method of claim 1, the access concentrator being a layer 2 tunnel protocol (L2TP) access concentrator.

4. The method of claim 1, the secret information including a secret key and a security system for performing encryption of the first data.

5. The method of claim 4, the security system corresponding to null encryption system.

6. The method of claim 1, said transmitting being performed with layer 2 tunnel protocol (L2TP).

7. The method of claim 6, the server information corresponding to layer 2 tunnel protocol (L2TP) information, the first network server being a layer 2 tunnel protocol network server.

8. The method of claim 7, the access concentrator being a layer 2 tunnel protocol (L2TP) access concentrator.

9. The method of claim 8, said transmitting of the first access request including sending the first access request from the access concentrator through Internet to the remote authentication dial-in user service (RADIUS) server, said transferring of the server information and the secret information including sending the server information and the secret information from the remote authentication dial-in user service server through the Internet to the access concentrator, said sending of the encoded first data including sending the encoded first data from the access concentrator through the Internet to the first network server.

10. The method of claim 9, the secret information including a secret key and a security system for performing encryption of the first data.

11. The method of claim 1, the encoded first data being conveyed through the Internet when being sent from the access concentrator to the first network server.

12. The method of claim 1, the subscriber corresponding to a computer system, the subscriber and the first network server being separated by the access concentrator.

13. A system for securely accessing a network, the system comprising:
a first device receiving a first request from a user when the user requests access to a virtual private network;
a second device sensing the first request when said first device transmits the first request; and
a third device being connected to the virtual private network, said third device being in communication with said first and second devices;
said second device transferring first information of said third device to said first device in response to the first request, said second device transferring secret information to said first device in response to the first request;
said first device receiving first data generated by the user, said first device encoding the first data in dependence upon the secret information, said first device sending the encoded first data to said third device;
said third device receiving the encoded first data from said first device, decoding the encoded first data, and then conveying the decoded first data to the virtual private network, the decoding being performed in dependence upon the secret information.

14. The system of claim 13, said first device corresponding to an access concentrator, said second device corresponding to a remote authentication dial-in user service (RADIUS) server, said third device corresponding to a network server.

15. The system of claim 13, said first device corresponding to a layer 2 tunnel protocol (L2TP) access concentrator, said second device corresponding to a remote authentication dial-in user service (RADIUS) server, said third device corresponding to a layer 2 tunnel protocol network server.

16. The system of claim 15, at least one device selected from among said first and second devices performing encryption on the secret information with a security system.

17. The system of claim 16, the security system being null encryption system.

18. The system of claim 13, said second device sensing the first request when said first device transmits the first request through Internet to said second device, said second device transferring the secret information through the Internet to said first device, said first device sending the encoded first data through the Internet to said third device, said third device not sending the decoded first data through the Internet.

19. The system of claim 18, said first device corresponding to a layer 2 tunnel protocol (L2TP) access concentrator, said second device corresponding to a remote authentication dial-in user service (RADIUS) server, said third device corresponding to a layer 2 tunnel protocol network server.

20. The system of claim 19, the first information including layer 2 tunnel protocol (L2TP) information.

21. A computer-readable medium having a set of computer-executable instructions for performing a method for securely accessing a virtual private network in a communication network, the set of instructions comprising one or more instructions for:
transmitting a first access request from an access concentrator to a remote authentication dial-in user service (RADIUS) server when a subscriber requests access to a virtual private network;
transferring server information and secret information of a first network server to the access concentrator, said transferring being performed in response to the first access request, the first network server being connected to the virtual private network;
when the server information and the secret information are received by the access concentrator, encoding first data in dependence upon the secret information, said encoding being performed by the access concentrator, the first data being generated by the subscriber;
sending the encoded first data from the access concentrator to the first network server in dependence upon the server information;
decoding the encoded first data at the first network server, said decoding being performed in dependence upon the secret information; and
conveying the decoded first data from the first network server to the virtual private network.

22. The computer-readable medium of claim 21, the server information including layer 2 tunnel protocol (L2TP) information, the first network server being a layer 2 tunnel protocol network server.

23. The computer-readable medium of claim 21, the access concentrator being a layer tunnel protocol (L2TP) access concentrator.

24. The computer-readable medium of claim 21, the secret information including a secret key and a security system for performing encryption of the first data.

25. The computer-readable medium of claim 24, the security system corresponding to null encryption system.

26. The computer-readable medium of claim 21, said transmitting being performed with layer 2 tunnel protocol (L2TP).
